(19) United States
(12) Patent Application Publication
(10) Pub. No.: US 2025/0290376 A1
(43) Pub. Date: Sep. 18, 2025

(54) Daylight-Sensing System and Method for Closed-Loop Daylight Control with a Horizontal Venetian Blind

(71) Applicant: Pradeep Pranjivan Popat, Arlington, VA (US)

(72) Inventor: Pradeep Pranjivan Popat, Arlington, VA (US)

(21) Appl. No.: 18/608,923

(22) Filed: Mar. 18, 2024

Related U.S. Application Data
(60) Provisional application No. 63/492,231, filed on Mar. 25, 2023.

(51) Int. Cl. E06B 9/38; E06B 9/24; G01J 3/28

(52) U.S. Cl. CPC E06B 9/38; G01J 3/28; E06B 2009/2417

(57) ABSTRACT

Disclosed is a daylight-sensing system to sense daylight admitted by a horizontal venetian blind. The system includes a sensor whose output is adjusted as a function of the blind's slat-tilt setting. Optionally, the adjustment function also depends upon the location of the sensor relative to the blind. Optionally, the adjustment function also depends upon the prevailing sky conditions.

### CROSS-REFERENCE TO RELATED APPLICATIONS

I hereby claim benefit under Title 35, United States Code, Section 119(e) of U.S. provisional patent application Ser. No. 63/492,231, filed Mar. 25, 2023, which is currently pending as of the filing of this application.

### BACKGROUND OF THE INVENTION

Systems which automatically adjust a window-shading device to one of two fixed settings (e.g. opened and closed), in response to changing conditions, have been available for decades. Such systems include those which provide automatic “open at dawn, close at dusk” operation, and those which are intended to automatically provide maximum shading in the presence of direct sunlight. Because the shading is adjusted only to fixed positions, such systems can be viewed as providing discontinuous daylight control.

A more sophisticated form of automated shading is one which provides continuous daylight control, adjusting shading only as much as necessary to regulate the admitted daylight. Such a continuous control capability is referred to herein as automatic daylight control.

It is well-known in the art that automatic daylight control can significantly increase the average level of glare-free natural illumination in indoor spaces, when compared to either discontinuous automatic or manual control. That, in turn, can provide a healthier and more appealing visual environment, while also increasing the energy savings achievable through daylight-harvesting lighting strategies.

Unfortunately, current automatic daylight control technologies are too expensive and complex to be considered cost-effective for commercial use, especially in the U.S.

### 1.0 the Trend Toward “Smart Actuators” for Shading Automation

Some of the cost and complexity associated with automatic daylight control is shared with automated shading systems in general, and is associated with the required motorized shading device.

To minimize this cost and complexity, the trend in automated shading has been toward smart actuators which incorporate control and motorization functionality in a small, self-contained module which can be easily retrofitted to manually-operated shading devices. Particularly advantageous are smart actuators which can be retrofitted without modification to the host shading device, which reduces cost and facilitates installation.

The smart-actuator approach is especially advantageous when applied to wand-operated horizontal blinds. Such blinds are inexpensive and widely deployed (especially in the U.S.), and their slat-tilt function can be automated with a relatively small and inexpensive actuator mounted on (or near) the blind's headrail. Such a smart actuator for wand-operated blinds was shown, for example, in U.S. Pat. No. 5,760,558 (1998), and similar devices have been commercially available for many years.

### 2.0 the Advantages of Horizontal Blinds for Daylight Control

Among cost-effective shading devices, horizontal blinds are particularly advantageous for automatic daylight control because their slat-tilt function can provide excellent control of admitted daylight. A key advantage is that appropriate adjustment of a horizontal blind's slat tilt can block glare-inducing direct sunlight while still admitting a desired amount diffuse daylight, and the admitted daylight can be controlled with a high degree of granularity via relatively unobtrusive tilt adjustments. No other cost-effective shading device offers such a capability.

Thus, using a smart actuator to automate the slat-tilt function of horizontal blinds offers a promising path toward a commercially viable automatic daylight-control capability. Unfortunately, the limitations of conventional technology have precluded realization of the full potential of this approach.

3.0 Disadvantages of Open-Loop Daylight Control with Horizontal Blinds

While both closed-loop and open-loop approaches for automatic daylight control are known in the art, most attempts to implement automatic daylight control with horizontal blinds have used the open-loop approach. However, there are four significant challenges associated with open-loop of daylight control using horizontal blinds.

The first is that open-loop control with horizontal blinds depends on inferring the admitted daylight on the basis of an assumed blind transfer function. As is known in the art, the optical transfer function of a horizontal blind is complex, and characterizing it sufficiently well for effective daylight control can require a specialized and lengthy system set-up process.

Second, open-loop daylight control with horizontal blinds requires tracking of the absolute tilt angle of the slats. One means of obtaining this information is a slat-tilt sensor affixed to one of the blind's slats, but this requires a separate assembly, can be unsightly, and adds an additional step to the set-up process. The other recognized means of obtaining this information is by calibrating the absolute slat-tilt angle against the motor's angular position, but this also complicates the set-up process and requires a means of accounting for the effects of mechanical backlash.

Third, open-loop control requires sensing the daylight irradiance on the outward-facing side of the blind. This cannot be done with a sensor that is integrated into a smart actuator module mounted on the front of the blind, but instead requires a sensor that located between the blind and the window, on the window itself, or outside the window. In addition to a separate sensor module, all of these approaches add an additional step to system installation and require a wired or wireless interface to the sensor module, increasing cost and complexity and spoiling the “single unit” elegance of the smart-actuator approach.

Finally, part of the complexity in the transfer function of a horizontal blind arises from the fact that the admitted daylight depends not just on the total irradiance on the outward-facing side of the blind, but also on the angular distribution of that irradiance. The latter is prohibitively difficult to sense, so most open-loop control approaches ignore the angular distribution of irradiance except when direct sunlight is incident on the window, in which case the blind's slats are automatically tilted to block that direct sunlight. This is done by inferring the solar azimuth and elevation on the basis of the time of day, day of year, and window latitude, longitude, and compass orientation. However, the need for information on window latitude, longitude, and compass orientation adds another step to the system set-up process.

For these reasons, while open-loop control currently appears to be the preferred way to use horizontal blinds for automatic daylight control, it has so far achieved limited commercial acceptance in the U.S.

Further, as is well-known in the art, the relatively few open-loop daylight control systems which have been commercially deployed (which typically use roller-shades rather than horizontal blinds) are generally poorly accepted by building occupants. Frequently-cited complaints include failure to open the shading when there is no risk of glare, and failure to close the shading when there is significant daylight glare.

4.0 Challenges in Closed-Loop Daylight Control with Horizontal Blinds

Closed-loop operation offers several compelling advantages over open-loop operation for daylight control with horizontal blinds: it avoids the need for (1) characterization of the blind's transfer function, (2) information on the absolute tilt angle of the slats; (3) sensing the irradiance on the outside of the blind, and (3) sensing or inferring the irradiance's angular distribution. Further, closed-loop operation offers the promise of more reliable control of the admitted daylight than possible with open-loop operation—provided that there is a suitable means of sensing that admitted daylight.

Unfortunately, closed-loop daylight control with a venetian blind (whether horizontal or vertical) is hampered by the fact that a blind's slat-tilt function modulates not just the radiant flux admitted by the blind, but also the angular distribution of the admitted flux. Thus, as a blind's slat tilt is adjusted, the daylight flux admitted in one direction can increase, while the flux admitted in another direction can decrease.

Therefore, if a conventional sensor is used to sense the admitted daylight, it must be positioned and oriented to sense the daylight from the same perspective as the building occupants; otherwise, its output will not vary with slat tilt in the same way as the daylight perceived by the occupants.

Unfortunately, positioning a sensor in this way makes it visually and physically obtrusive (while also incurring all of the disadvantages of the need for a separate sensor assembly, i.e. increased cost and installation complexity).

### PRIOR ART

The above-described challenges of sensing the daylight admitted by a horizontal blind are addressed in U.S. Pat. No. 11,041,752. Disclosed therein are two approaches to employing a headrail-mounted sensor to sense the daylight admitted by a horizontal blind:
a. use of a conventional scalar irradiance sensor with an optimized field-of-view, and
b. use of a vector sensor (referred to therein as an “angle-diversity sensor”) which includes at least two sensor elements with differing fields-of-view and whose outputs are processed in a particular way.

Both sensing approaches offer improved correlation between the sensor output signal and the admitted daylight, as perceived by the room occupants, when compared with a conventional scalar sensor collocated with the blind.

However, there can still be significant decorrelation between changes in the sensor output and in the perceived daylight under certain sky conditions. This is especially true with the scalar sensor, but also occurs with the vector sensor:
a. In clear weather with no direct sunlight incident on the window, the ground outside the window can be brighter than the sky. If the blind's slats are then tilted from horizontal so that their indoor edges move upwards, then the irradiance at the sensor will increase while the daylight perceived by the occupants will decrease.
b. Another issue can occur when there is direct sunlight incident on the blind's slats: at certain tilt angles, the irradiance at the sensor can be dominated by direct sunlight reflected from the slats, changing the sensor output substantially without affecting the daylight perceived by the building occupants.

Such de-correlations between changes in the sensor output and in the perceived daylight level cause the system to over-tilt the slats during automatic adjustments. While this behavior occurs less frequently with the sensing approaches of U.S. Pat. No. 11,041,752 than with a conventional sensor, it still occurs often enough (particularly with the scalar sensor disclosed therein) to be noticeable by building occupants, creating the perception that the system is operating improperly.

Further, these sensors' field-of-view requirements can make them difficult to integrate into a small smart actuator module. This is particularly true of the angle-diversity sensor, which requires a broad aggregate field-of-view divided in a particular way among multiple sensing elements.

Insofar as is known at the time of this disclosure, commercial deployment of closed-loop daylight control systems employing horizontal blinds is virtually non-existent, at least in the U.S.

### SUMMARY OF PRIOR-ART LIMITATIONS

In summary, while automatic daylight control with horizontal blinds offers numerous benefits, prior-art approaches for implementing such a system suffer from excessive cost, complexity, or poor performance due to the limitations of conventional daylight-sensing technology.

For open-loop daylight control with a horizontal blind, conventional sensor technology suffers from all of the following limitations:
a. the need to characterize the blind's transfer function, complicating the system set-up process;
b. the need for information regarding the absolute tilt angle of the slats, which requires either a slat-tilt sensor affixed to one of the blind's slats (which represents significant cost and adds another step to the installation process) or calibration of the absolute slat-tilt angle against the motor's angular position (which adds another step to the set-up process);
c. the need to sense the daylight irradiance on the outward-facing side of the blind, requiring a sensor module that is physically separate from the other automation components (which is more expensive than an integrated sensor and adds another step to the installation process); and
d. the need to sense or infer the angular distribution of the irradiance incident on the outward-facing side of the blind, which requires either a specialized vector sensor (which is larger and more expensive than a conventional scalar sensor) or a set-up process that comprehends the window's latitude, longitude, and compass orientation in order to enable inferring of the solar azimuth and elevation.

For closed-loop daylight control with a horizontal blind, conventional sensor technology suffers from at least one of the following limitations:
a. a sensor output which is insufficiently correlated with the admitted daylight as perceived by the building occupants;
b. the need for a sensor which senses the admitted daylight from the same perspective as the building occupants, and which is therefore visually and physically obtrusive and must be packaged separately from the other blind-automation components, thereby increasing cost and installation complexity relative to an integrated sensor; or
c. the need for a vector sensor optimized for collocation with the other blind-automation components (e.g. per the angle-diversity sensor shown in U.S. Pat. No. 11,041,752), and which is therefore more expensive and difficult to integrate than a conventional scalar sensor.

### OBJECT OF THE INVENTION

It is therefore an object of the invention disclosed herein to provide a daylight-sensing system and method for automatic daylight control with a horizontal venetian blind, and which:
a. can be collocated with the blind, avoiding the cost and complexity of a remote sensor;
b. does not have specific field-of-view requirements or require multiple sensor elements and is therefore easy to integrate in a small headrail-mounted smart actuator;
c. does not require a slat-tilt sensor or calibration of the absolute slat tilt against motor positon; and
d. provides a signal which is sufficiently well-correlated with the admitted daylight as perceived by building occupants to enable effective daylight control in virtually all sky conditions.

Further objects and advantages will become apparent from a consideration of the drawings and accompanying description.

### SUMMARY OF THE INVENTION

The subject invention is a daylight-sensing system and method for closed-loop daylight control with a horizontal venetian blind. The system includes a daylight irradiance sensor with no specific field-of-view or positioning requirements to sense a component of the admitted daylight passing through the blind.

As taught in U.S. Pat. No. 11,041,752, the output of such a sensor can be poorly correlated with the perceived blind luminance under certain conditions. The subject invention overcomes this problem by adjusting the sensor output as a function of the blind's tilt setting according to an adjustment function, and optionally also according to information characterizing the prevailing sky conditions, to produce an output signal for use as the process variable for closed-loop control. Because the adjustment is based on the tilt setting (and not the absolute slat tilt angle), no slat-tilt sensor (or calibration of slat tilt versus motor position) is needed, and the adjustment function can be independent of the blind's design. When the closed-loop control setpoint is selected to cause the blind to block direct sunlight, the output signal of the sensing system remains well-correlated with the perceived luminance of the blind over the blind's slat-tilt adjustment range and over a wide range of sky conditions.

The subject invention thus enables a simple, low-cost daylight-sensing system that can be collocated with the blind, is easy to integrate in a small blind-automation device, is easy to install, and yet provides excellent closed-loop control of admitted daylight, thereby avoiding the problems associated with open-loop control.

### BRIEF DESCRIPTION OF DRAWINGS

FIGS. 1A-1C depict side views of a horizontal venetian blind in three settings, in order to illustrate the convention regarding slat tilt angles used in describing the subject invention.

FIG. 2 shows a side view of a room in which a horizontal venetian blind and collocated daylight sensor are installed, along with key components of the daylight admitted by the blind.

FIG. 3 shows plots of normalized raw sensor output and blind luminance versus slat-tilt setting, under various sky conditions, for the configuration of FIG. 2.

FIG. 4 shows a block diagram of an exemplar preferred embodiment of a daylight-sensing system according to the subject invention.

FIG. 5 shows a plot of a sensor adjustment value versus slat tilt setting, as defined by an exemplar adjustment function according to the subject invention.

FIG. 6 shows plots of a daylight signal produced by the daylight-sensing system of FIG. 4 (obtained by applying the adjustment value per FIG. 5 to the raw sensor output) versus slat-tilt setting, along with blind luminance versus slat-tilt setting, under the same conditions as for the plots of FIG. 3.

FIG. 7 shows plots of sensor adjustment value versus slat tilt setting for two adjustment functions according to the subject invention: the adjustment function of FIG. 5 and an alternative adjustment function.

FIG. 8 shows plots of a daylight signal produced by the daylight-sensing system of FIG. 4 versus slat-tilt setting, along with blind luminance versus slat-tilt setting, under the same conditions as for the plots of FIG. 3 but with the daylight signal obtained using the alternative adjustment function of FIG. 7 instead of that of FIG. 5.

FIG. 9 shows a block diagram of an alternative embodiment of a daylight-sensing system according to the subject invention which implements an exemplar adaptive adjustment function using the output of a multi-spectral sensor.

FIG. 10 shows a plot of the exponent value versus NIR-to-NUV irradiance ratio for the exemplar adaptive adjustment function implemented by the system of FIG. 9.

FIG. 11 shows a side view of a room in which a horizontal venetian blind and ceiling-mounted daylight sensor are installed, along with key components of the daylight admitted by the blind.

FIG. 12 shows a plot of the sensor adjustment value versus slat tilt setting for an exemplar adjustment function for a ceiling-mounted sensor as depicted in FIG. 11.

FIG. 13 shows a block diagram of a smart actuator module which incorporates a daylight-sensing system according to the subject invention.

FIG. 14 depicts the smart actuator module of FIG. 13 installed on a horizontal blind.

FIG. 15 is a flowchart of the software operating steps for closed-loop daylight control performed by the smart actuator module of FIG. 13, which are executed while the blind is not being adjusted.

FIG. 16 is a flowchart of the software operating steps for closed-loop daylight control performed by the smart actuator module of FIG. 13, which are executed while the blind is being adjusted.

FIG. 17 shows a block diagram of a conventional automated blind which is augmented with a daylight-sensing system according to the subject invention to provide automatic daylight-control capability.

### DETAILED DESCRIPTION OF THE INVENTION

### 1 Convention Regarding Special Terms and Variables

Italicized but un-bolded text is used herein for the first use of special terms whose meanings are defined in the LIST OF SPECIAL TERMS. Italicized and bolded text are used herein for variables and parameters.

### 2 List of Special Terms

Adjustment function: A function whose at least one independent variable is the tilt setting of a venetian blind, and whose at least one dependent variable is an adjustment value which is used to adjust a sensor output signal according to the subject invention.

Admitted daylight: Daylight which passes through a window-shading device into an interior space. See also the related terms perceived daylight and perceived luminance.

Automatic daylight control (equivalent to automated daylight control): The capability for automated control of admitted daylight in response to changing conditions, in which a shading device is adjusted substantially continuously over its adjustment range rather than discontinuously between two settings.

Characterizing (as in “characterizing the sky condition”): The act of obtaining information on the relevant characteristics of something, e.g. “characterizing the sky condition” means to obtain information on the characteristics of the sky which can affect the daylight admitted by a shading device.

Closed setting (of horizontal blind): A tilt setting of a horizontal blind intended to minimize the amount of daylight it admits. This is usually, but not always, a positive-tilt setting.

Component (of admitted daylight): A portion of the daylight irradiance admitted by a shading device, whether at visible or non-visible wavelengths and whether direct or reflected.

Multi-spectral sensor: A sensor whose output is a function of the irradiances in at least two spectral passbands.

Negative tilt setting (of horizontal blind): A tilt setting of a horizontal blind such that the outward view of the sky is less obstructed than the outward view of the ground.

Open setting (of horizontal blind): A tilt setting of a horizontal blind which represents the preferred setting when there is no risk of daylight glare; this will typically be chosen to provide a minimally-obstructed outward view through the blind or to maximize the admitted daylight.

Perceived blind luminance: The luminance of a venetian blind as perceived by an occupant of the space in which the blind is mounted.

Perceived daylight level: The daylight level perceived by the occupant of a daylit space.

Positive tilt setting (of horizontal blind): A tilt setting of a horizontal blind such that the outward view of the ground is less obstructed than the outward view of the sky.

Sky condition: The condition of the sky (including but not limited to the weather, the presence of clouds, cloud type and density, and the solar azimuth and elevation) which can affect the daylight admitted by a window-shading device.

Smart actuator: A device which can automate the operation of a manually operated device, such as a manually-operated blind.

Software: Used herein to refer to what is conventionally meant by either software or firmware; refers to any programmed operations executed by a computing device.

Tilt setting (of a horizontal blind): The slat-tilt angle expressed in arbitrary units. The tilt setting can represent, e.g., an absolute tilt angle (e.g. in degrees or radians), or a relative tilt angle with respect to the blind's tilt-adjustment limits (e.g. such that 100 represents the positive tilt setting limit and −100 represents the negative tilt setting limit), or the relative angular displacement of the blind's tilt-adjustment shaft with respect to the tilt-adjustment limits (e.g. such that 100 represents the positive tilt setting limit and −100 represents the negative tilt setting limit).

Zero tilt setting (of horizontal blind): A tilt setting of a horizontal blind in which the slats are approximately horizontal.

### 3 Introduction

The subject invention is intended to enable closed-loop daylight control with a horizontal blind. Therefore, in order to facilitate a complete understanding of the invention, the following description first discusses key requirements for effective daylight control in general, then provides a more detailed description of the aforementioned challenges associated with the use of horizontal blinds, and finally proceeds to a detailed description of the invention and its applications.

### 4 Requirements for Effective Daylight Control with Automated Shading

The purpose of an automatic daylight control system is to regulate the daylight in a daylit space as perceived by the occupants of that space. Two key issues in the design of such a system are (1) what metric to use to characterize the daylight as perceived by the occupants, and (2) how accurately the daylight must be regulated in terms of that metric.

Regarding the first issue, there is general agreement in the art that the perceived daylight level can be appropriately characterized either by the luminance of the shaded window, or by the daylight component of the illuminance on a vertical surface facing the window.

On the other hand, the second issue is virtually unaddressed in the prior art. However, research leading to development of the subject invention has revealed the following facts regarding accuracy requirements for effective automatic daylight control:
a. Absolute accuracy (in terms of standard photometric units, e.g. for luminance or illuminance) is unimportant. This is because an automatic daylight-control system must have an occupant-adjustable daylight set-point in order to be accepted by building occupants. Thus, it is the accuracy of daylight regulation relative to that set-point, and not the absolute accuracy in photometric units, that matters.
b. Occupants are tolerant of surprisingly large changes in the regulated daylight level when those changes occur slowly, e.g. over a period of hours or days. Thus, long-term relative accuracy is unimportant.
c. On the other hand, occupants are very sensitive to short-term relative inaccuracies in the regulated daylight level. In subjectively gauging system accuracy, occupants appear to be sampling the daylight level immediately following each automated shading adjustment; perceptible differences between these post-adjustment daylight levels are readily perceived as inaccuracies. Occupants appear to be especially sensitive to differences in the perceived daylight levels following successive automated shading adjustments. Thus, short-term relative accuracy is important, and particularly the consistency of daylight levels immediately following successive automated shading adjustments.

In summary, the process variable used for automatic daylight control should be correlated to the luminance of the shaded window as perceived by occupants of the daylit space, but it need not be calibrated in terms of standard photometric units. Further, while the relationship between the process variable and the perceived luminance can drift over hours or days, it should ideally be constant over shorter time scales—and particularly between successive automated shading adjustments.

### 5 Achieving Effective Daylight Control with Horizontal Blinds

As briefly described earlier in this disclosure, horizontal blinds are uniquely well-suited for automatic daylight control, but also present unique challenges in that context. Before describing these challenges in more detail, the following section reviews key considerations in the use of horizontal blinds for daylight control.

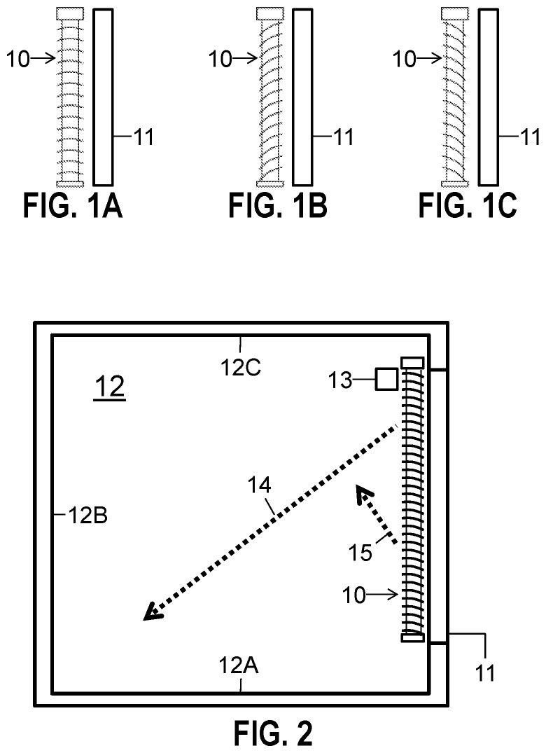

5.1 Slat-Tilt Range for Daylight Control with a Horizontal Blind: FIGS. 1A-1C

A horizontal blind's slats can typically be tilted over a range approaching 180 degrees. However, as is known in the art, daylight control with a horizontal blind is facilitated when only approximately half of the blind's tilt range is used. This can best be explained with reference to FIGS. 1A-1C.

FIG. 1A depicts a side view of a horizontal venetian blind 10 mounted on a window 11 with the blind's slats oriented so that they are horizontal. This setting is referred to herein as the zero-tilt setting. A zero-tilt setting admits plenty of daylight and provides the best outward view through the blind, so most building occupants prefer a near-zero tilt setting when there is no risk of glare.

FIG. 1B depicts blind 10 with its slats tilted to allow a view of the sky while blocking a view of the ground. Such slat tilt angles which tend to block a ground view, but allow a sky view, are considered herein to be negative tilt angles, and such a setting is referred to herein as a negative-tilt setting. A negative-tilt setting can admit even more daylight than a zero-tilt setting, but can also admit excessive glare when the sky is bright. In particular, a negative tilt setting cannot selectively block direct sun while also admitting diffuse daylight.

FIG. 1C depicts blind 10 with its slats tilted to allow a view of the ground while blocking a view of the sky. Such slat-tilt angles which tend to block a sky view, but allow a ground view, are considered herein to be positive tilt angles, and such a setting is referred to herein as a positive-tilt setting. A positive-tilt setting can block direct sunlight while still admitting substantial amounts of diffuse daylight.

Because positive tilt settings are capable of blocking direct sun while still admitting useful diffuse daylight, the optimum tilt-setting range for daylight control with a horizontal blind is between a near-zero tilt setting and the maximum positive tilt setting.

### 5.1.1 Absolute Slat Tilt Angle Versus Slat Tilt Setting

In an open-loop daylight-control system using horizontal blinds, the control algorithm typically requires the absolute slat tilt angle (e.g. in degrees with respect to the horizontal axis) in order to effectively block direct sunlight. Determining this absolute slat-tilt angle with sufficient accuracy requires either a two-axis accelerometer affixed to one of the blind's slats, or a calibration curve of the absolute slat-tilt angle versus motor position (as well an algorithm to account for any mechanical backlash in the tilter mechanism).

A major advantage of closed-loop daylight-control systems is that they do not require absolute slat-tilt angle data to effectively block direct sunlight (which happens automatically as a byproduct of closed-loop control). Instead, like motorized blinds which do not attempt to provide automatic daylight control, a closed-loop control algorithm needs to know only when the blind's tilt setting limits have been reached. This, in turn, requires only information regarding the current motor position (e.g. as determined via a shaft encoder) relative to the blind's tilt-adjustment limits.

In a typical motorized blind, these tilt-adjustment limits are established during system set-up by storing three motor positions into the system's memory:
a. The motor position at the blind's negative tilt setting limit (per FIG. 1B). For a typical blind, this corresponds to an absolute tilt angle of about-70 degrees.
b. The motor position at the blind's positive tilt setting limit (per FIG. 1C). For a typical blind, this corresponds to an absolute tilt angle of about 70 degrees. This limit is referred to herein as the closed setting.
c. The motor position corresponding to the user's preferred setting when there is no risk of glare. This absolute tilt angle of this open setting is typically between −20 and 0 degrees. This setting is referred to herein as the open setting.

At the conclusion of the set-up process, these motor positions are typically scaled by the system to arbitrary tilt-setting units, such that each tilt-adjustment limit always corresponds to a particular tilt setting (e.g. −100 for the negative tilt limit and 100 for the closed setting), regardless of the actual motor position (e.g. in encoder pulse counts). Such fixed values of the tilt setting limits simplify the user interface for manual control of the system, as well as the algorithm for automatic control.

The slat tilt settings referenced in the balance of this disclosure are in terms of such arbitrary tilt setting units, such that the closed setting always has a value of 100, the open setting always has a value of 0, and the negative tilt setting limit always has a value of −100.

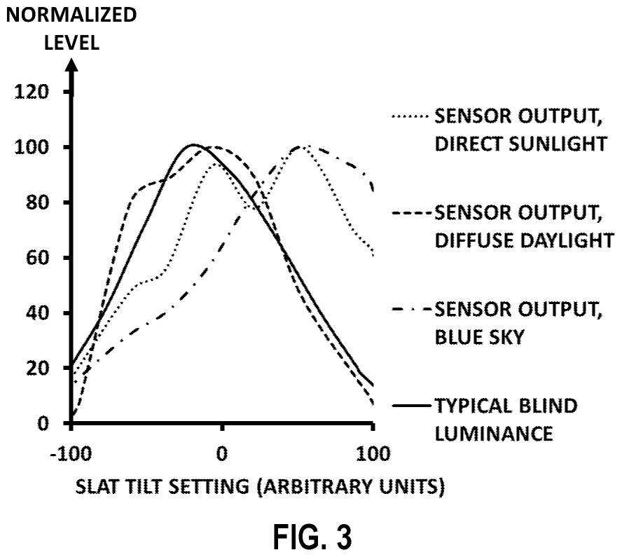

5.2 Challenges in Using a Daylight Senor Co-Located with a Horizontal Blind: FIGS. 2 and 3

While restricting the slat tilt to only positive settings facilitates daylight control per se with a horizontal blind, it creates problems for closed-loop daylight control using a daylight sensor co-located with the blind. These problems, which are overcome by the subject invention, are described below.

### 5.2.1 FIG. 2: Daylight Components Admitted by a Horizontal Blind

FIG. 2 shows a side view of blind 10 and window 11 in a room 12, with a daylight irradiance sensor 13 co-located with the blind and mounted on the blind's headrail.

Incident daylight passes through window 11 and blind 10 into room 12, reaching sensor 13 either directly or indirectly (via reflection from surfaces within the room, such as a floor 12A, wall 12B, and ceiling 12C). Two components of the daylight admitted by blind 10 into room 12 are shown.

First, a daylight component 14 is admitted into room 12 along a trajectory that is approximately collinear with the line-of-sight of a person viewing blind 10 from within the room. The irradiance of component 14 is therefore well-correlated with the luminance of blind 10 as perceived by a person in room 12. Component 14 can be due to either diffuse daylight (e.g. from an overcast sky) or direct sunlight, and is maximized when blind 10 has a negative tilt setting.

Second, a daylight component 15 is admitted into room 12 along a generally upward trajectory which is misaligned with the typical perspective of a person viewing blind 10 from within room 12. The irradiance of component 15 is thus poorly correlated with the perceived blind luminance. Component 15 is primarily due to one of two sub-components:
a. Skylight reflected upward from the ground outside window 10. This sub-component is maximized when blind 10 has a positive tilt setting.
b. Reflection of component 14 from the blind's slats toward ceiling 12C and sensor 13. This component is maximized when blind 10 has a near-zero tilt setting.

For purposes of this description, sensor 13 can be assumed to have an approximately cosine angular response with peak sensitivity aligned with component 14; the effects of different angular responses are addressed subsequently.

Some of the irradiance of components 14 and 15 will reach sensor 13 either directly or (typically to a greater extent) indirectly by reflection from surfaces within the room. If the irradiance reaching sensor 13 due to component 14 is much greater than that due to component 15, then the output of sensor 13 will be well-correlated with the perceived luminance of blind 10 as its tilt setting is adjusted.

However, if component 15 represents a significant fraction of the overall irradiance reaching sensor 13, then the output of sensor 13 will vary differently with the tilt setting than does the blind luminance. This is especially likely in two circumstances:
a. When direct sunlight is incident on window 11, but the slats of blind 10 have been tilted (either manually or automatically) to block it so that it is excluded from component 14. If the slats are not fully closed, some of the direct sunlight will be reflected upwards toward ceiling 12C via component 15, then reflected from ceiling 12C to floor 12A and wall 12B, and finally reflected from floor 12A and wall 12B to sensor 13. Due to the very high absolute irradiance of direct sunlight, enough of it can reach sensor 13 via this indirect path to dominate the sensor output at certain tilt settings.
b. In clear blue skies when there is no direct sunlight incident on window 11. Under such conditions, the irradiance on window 11 can be dominated by ground-reflected skylight. This can pass unimpeded through the slats at positive tilt settings, causing component 15 to be much larger than component 14. Component 15 can then reach sensor 13 via reflections from ceiling 12C and then floor 12A and wall 12B, causing component 15 to dominate the sensor output.

The effects of the resulting decorrelation between the output of sensor 13 and the perceived blind luminance is described in more detail below.

### 5.2.2 FIG. 3: Output of Sensor 13 Versus Slat Tilt Setting

FIG. 3 plots four sets of data collected during testing of the blind-sensor combination shown in FIG. 2. The x-axis represents the slat-tilt setting of blind 10 in arbitrary units (wherein 100 represents the blind's positive slat tilt limit, −100 represents the blind's negative slat-tilt limit, and 0 represents the zero-tilt setting). The four sets of data are as follows.

The various broken lines represent the output sensor 13 (normalized to a peak value of 100) versus tilt setting for three different sky conditions:
a. The data of the “direct sunlight” curve were taken when the solar disc was at an elevation of 27 degrees and within the window's field of view.
b. The data of the “diffuse daylight” curve was taken with the solar disc at an elevation of 20 degrees and within the window's field-of-view, but partly obscured by thin clouds, resulting in a uniformly bright sky.
c. The data of the “blue sky” curve was taken with a mostly clear sky and the solar disc out of the window's field-of-view (at an elevation of 72 degrees).

The solid line represents the typical luminance of blind 10 (again normalized to a peak value of 100) versus tilt setting, observed from a height of 3 feet from the floor (which is the typical eye height for a seated person) and at a horizontal distance of 1 window-height (approximately 8 feet in the test installation of FIG. 3) from the blind. In general, the shape of a normalized blind luminance curve such as this does vary with sky conditions, but to a much smaller extent than the sensor output curves of FIG. 3. Thus, for the purposes of this description, the single luminance curve of FIG. 3 can be considered to be representative of all three sky conditions.

Note that of the three sensor curves, only the Diffuse Daylight curve has a shape which resembles the luminance curve. Referring again to FIG. 2, this is because the daylight irradiance represented by component 14 is much greater than that represented by component 15.

On the other hand, the other two sensor curves have shapes which differ significantly from that of the luminance curve. Specifically, the Direct Sunlight and Blue Sky curves peak at much greater positive tilt settings than does the luminance curve. Referring again to FIG. 2, this is because the irradiance represented by component 15 is larger than that represented by component 14 under these conditions.

Thus, the difference between the shapes of the sensor and luminance curves for the Blue Sky and Direct Sunlight conditions cause the sensor output to be decorrelated with the blind luminance as the slats are tilted over positive tilt angles. Such decorrelation between sensor output and perceived luminance is problematic for closed-loop daylight control.

For example, consider a situation in which the sensor output as represented by the Blue Sky curve is used as the process variable for closed-loop control of daylight admitted by blind 10:
a. If the slats are at a tilt setting of 0 and the irradiance increases just enough to require an automatic slat adjustment, then the closed-loop control algorithm will increase the tilt setting. However, while the luminance will then begin to decrease, the output of sensor 13 will increase until a setting of approximately 50 is reached, before finally beginning to drop. Thus, the system will over-tilt the slats to the closed setting of 100 without sensor output ever dropping to below the value it originally had at the 0 setting.
b. Conversely, if the slats are at a setting of 50 when the irradiance decreases just enough to require a slat adjustment, the system will begin to decrease the tilt setting to increase the admitted daylight level. However, while the luminance is increasing, the output of sensor 13 will actually decrease. Thus, while only a small adjustment might be needed to maintain the perceived daylight level, the system will actually over-tilt the slats to the open setting

A similar over-tilting phenomenon (in which the slats are either over-closed or over-opened with each automatic slat-tilt adjustment) would occur if the sensor output as represented by the Direct Sunlight curve were used as the process variable for closed-loop control.

### 5.2.3 Impact of Over-Tilting Phenomenon on Occupant Acceptance

Testing shows that the over-tilting phenomenon described above is obvious and annoying to building occupants. This is exacerbated by the fact that successive automatic shading adjustments will over-tilt the slats in opposite directions, causing a large difference in the post-adjustment daylight levels between the two adjustments. This violates the previously-described requirement for short-term relative accuracy of the daylight regulation, and reinforces the impression that the system is operating improperly.

Such behavior is therefore a significant barrier to market acceptance of daylight-control systems.

5.2.4 Impact of Mitigation Measures Taught in U.S. Pat. No. 11,041,752

U.S. Pat. No. 11,041,752 teaches two measures to reduce the above-described decorrelation between the output of a blind-collocated daylight sensor and the perceived blind luminance.

The first measure involves use of a scalar sensor with an optimized field-of-view. In the context of FIG. 2, this can be accomplished by constraining the angular response of sensor 13 so that neither component 15, nor its reflection from ceiling 12C, can reach it. However, the effectiveness of this measure is limited by the fact that reflections of component 15 from ceiling 12C can still reach sensor 13 via subsequent reflection from floor 12A and wall 12B.

The second measure involves use of an angle-diversity (vector) sensor whose output is a function of the ratio of two sub-sensor outputs, one of which is more sensitive to component 14 and the other of which is more sensitive to component 15. This has been found to be more effective at reducing the above-described decorrelation phenomenon than possible just through optimization of the field-of-view. However, its ultimate effectiveness is also limited by the fact that multiple reflections can cause irradiance from component 15 to arrive at sensor 13 along the same trajectory as irradiance from component 14.

Therefore, while these measures reduce the severity of the decorrelation phenomenon described above, they are not sufficient to render it a non-issue for closed-loop daylight control. This is particularly true of the scalar sensor with optimized field-of-view.

Further, each of these measures imposes field-of-view requirements on the sensor(s), which can make them challenging to integrate in a blind-mounted smart actuator. This is particularly true of the angle-diversity sensor.

### 6 Preferred Embodiment

A preferred embodiment of the subject invention, which solves the above-described problems, is now described.

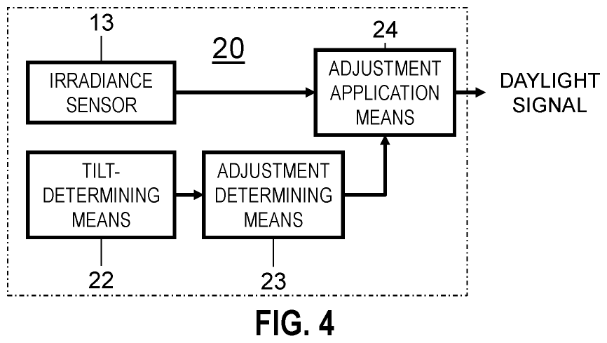

### 6.1 Block Diagram of Preferred Embodiment: FIG. 4

FIG. 4 shows a block diagram of a preferred embodiment of the subject invention, a daylight-sensing system 20 to sense the daylight admitted by a horizontal blind, and which consists of daylight irradiance sensor 13, tilt-determining means 22, adjustment-determining means 23, and adjustment-application means 24.

### 6.1.1 Daylight Irradiance Sensor 13

As previously described in reference to FIG. 2, the purpose of sensor 13 is to sense a component of daylight admitted by blind 10. If the only irradiance expected to reach sensor 13 were due to daylight, then sensor 13 could be substantially responsive to visible wavelengths.

However, in a typical application of system 20, artificial illumination (typically from fluorescent or LED lamps) will also reach sensor 13. In that case, sensor 13 should be responsive to wavelengths within the daylight spectrum but not to wavelengths produced by such lamps (otherwise, changes in the on/off state or brightness of the lamps would be incorrectly sensed as changes in the daylight level). As taught in as taught in U.S. Pat. No. 6,084,231, this requirement can be met if sensor 13 is responsive to only Near-InfraRed or Near-UltraViolet (NUV) wavelengths.

In the preferred embodiment, sensor 13 is an off-the-shelf photodiode-based NIR sensor with a digital serial output via the Inter-Integrated Circuit (I2C) protocol.

### 6.1.2 Tilt-Determining Means 22

Tilt-determining means 22 is a conventional means of obtaining a signal representing the tilt setting of the blind whose admitted daylight is to be sensed by sensor system 20 (e.g. blind 10 of FIG. 2).

The tilt setting signal produced by means 22 will typically and advantageously be a digital signal (i.e. a digital value in serial or parallel format), but could also be an analog signal.

Means 22 could be, for example, a shaft encoder or multi-turn potentiometer coupled to the blind's tilt-adjustment shaft, or a two-axis accelerometer affixed to one of the blind's slats, along with the necessary interface circuitry to produce a tilt setting signal.

Alternatively, because virtually all motorized blind systems (whether or not intended for closed-loop daylight control) include a controller which tracks the slat tilt setting, means 22 could be a wired or wireless interface to obtain existing tilt setting information if blind 10 is part of such a motorized blind system.

In the preferred embodiment, means 22 is simply an operating step in the controller of a motorized blind system to read the value of an existing tilt setting variable.

### 6.1.3 Adjustment-Determining Means 23

As previously discussed in reference to FIG. 2, the usefulness of the output of irradiance sensor 13 for closed-loop daylight control is degraded by the presence of spurious irradiance components (such as component 15) which cause the sensor output to be decorrelated with the blind luminance. The purpose of adjustment-determining means 23 is to produce an adjustment value which, when applied to the output of sensor 13, will mitigate the effects of such spurious components.

Accordingly, adjustment-determining means 23 is a means of producing an adjustment signal as a function of the tilt setting signal produced by tilt-determining means 22. Assuming that the tilt-setting signal produced by means 22 is a digital value, then adjustment-determining means 23 could consist, e.g., of operating steps executed by a microcontroller to evaluate a mathematical function, or execute a look-up table, on the basis of the tilt setting signal.

Alternatively, means 23 could include an analog-to-digital converter to accept an analog accelerometer or rotary potentiometer signal from means 22, prior to producing the adjustment signal in the digital domain as described above.

Alternatively, means 23 could operate entirely in the analog domain, e.g. by using an analog circuit to produce an adjustment signal as a function of an analog tilt-sensor or rotary potentiometer signal produced by means 22.

In the preferred embodiment, adjustment-determining means 23 consists of operating steps to evaluate a mathematical function, which steps are performed by the same microcontroller used to implement tilt-determining means 22.

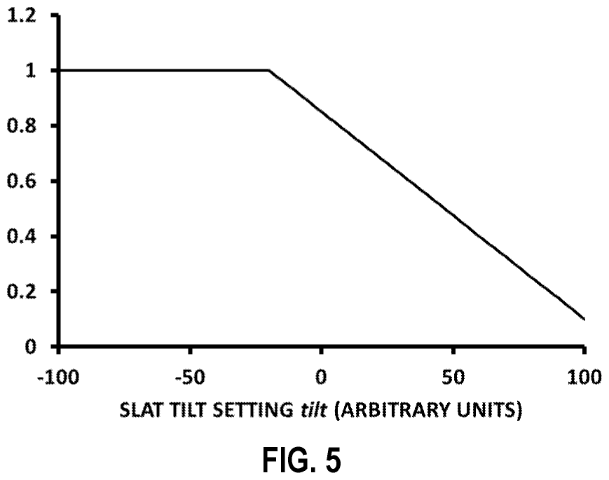

### 6.1.3.1 FIG. 5: Adjustment Function Implemented by Adjustment-Determining Means 23

As previously stated, adjustment-determining means 23 produces an adjustment signal as a function of the tilt setting signal produced by tilt-determining means 22. As will become apparent, an infinite number of adjustment functions are possible according to the subject invention.

However, FIG. 5 shows an adjustment function which has proven to work well in practice. It shows a plot of an adjustment value, a(tilt), produced by adjustment-determining means 23 as a function of the slat tilt setting tilt. The tilt setting tilt plotted on the x-axis is in arbitrary units as previously described, wherein a value of −100 corresponds to the negative tilt setting limit, 0 corresponds to the open setting, and 100 corresponds to the positive tilt setting limit (which is also the closed setting). It can be seen that adjustment function a(tilt) has a value of 1 for tilt settings of −20 and below, and decreases linearly for tilt settings above 1, reaching a minimum of 0.1 at a tilt setting of 100.

### 6.1.4 Adjustment Application Means 24

Adjustment application means 24 is conventional means of applying the adjustment signal produced by adjustment determining means 23 to the sensor signal produced by irradiance sensor 13. The implementation of adjustment means 24 will depend on that of sensor 13 and adjustment-determining means 23.

In the preferred embodiment, adjustment application means 24 consists of steps performed by the same microcontroller used to implement tilt-determining means 22 and adjustment-determining means 23, which steps implement the calculation d=s*a(tilt), where
a. d is the daylight signal produced by daylight-sensing system 20,
b. s is the output of sensor 13, and
c. a(tilt) is the value of the adjustment function, which is produced by adjustment-determining means 23 as a function of the tilt setting signal produced by tilt-determining means 22.

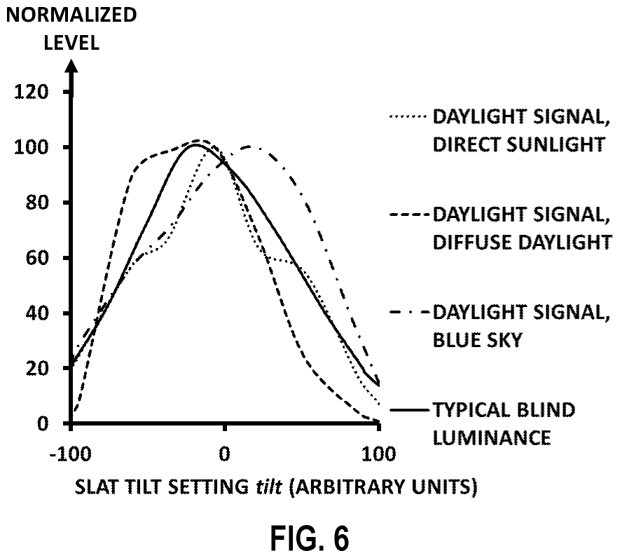

### 6.2 Daylight Signal Produced by Preferred Embodiment: FIG. 6

FIG. 6 shows plots of the daylight signal produced by daylight-sensing system 20, based on data collected at the same times and under the same conditions (and in the same test installation, as depicted in FIG. 2) as the data of FIG. 3. Note that the “typical blind luminance” curve is the same in both FIGS. 3 and 6.

When comparing FIG. 6 to FIG. 3, it is evident that two of the daylight signal curves of FIG. 6 curves match the luminance curve more closely than the corresponding sensor signal curves of FIG. 3, while the third daylight signal curve matches the luminance curve less closely:
a. The Direct Sunlight and Blue Sky daylight signal curves of FIG. 6 match the luminance curve much more closely than do the corresponding sensor curves of FIG. 3. In particular, the tilt settings at which these daylight signal curves peak are closer to the tilt setting at which the luminance curve peaks. As a result, if the daylight signal produced by system 20 were used as the process variable for closed-loop control, the risk of the over-adjustment phenomenon discussed previously would be completely eliminated under the conditions of the Direct Sunlight curve, and significantly reduced for the conditions of the Blue Sky curve.
b. On the other hand, the Diffuse Daylight curve of FIG. 6 matches the luminance curve less closely than the corresponding sensor curve of FIG. 3. Specifically, the daylight curve now falls off more quickly with positive tilt than does the luminance curve. As a result, if the daylight Signal produced by system 20 were used as the process variable for closed-loop control, the slats would be under-adjusted under the conditions of the Diffuse Daylight curve. However, testing shows that this behavior does not significantly affect occupant acceptance, because the system still provides a useful reduction in the dynamic range of the blind luminance and the under-adjustment is generally unnoticeable.

### 6.2.1 Relationship Between Daylight Signal and Absolute Blind Luminance

The preceding description addresses the relationship between curves of the normalized daylight signal and blind luminance versus slat tilt setting, but not the relationship between curves of the absolute daylight signal and blind luminance versus slat tilt setting.

This is because (as previously stated), testing associated with development of the subject invention reveals that regulation of admitted daylight in absolute photometric terms is unnecessary for effective automatic daylight control.

However, application of an adjustment function according to the subject invention does, in fact, appear to typically increase the absolute accuracy of the signal produced by a daylight sensor intended to sense the luminance of a horizontal blind.

### 6.2.2 Effectiveness of Daylight Control Based on Adjusted Daylight Signal

Daylight-sensing system 20 of FIG. 4 was used to provide the process-variable signal for closed-loop daylight control with horizontal blinds in several occupied buildings. A-B testing was performed to gauge occupant acceptance when using (A) the output of sensor 13, and (B) the adjusted daylight signal produced by system 20, as the process variable.

The testing showed that using the adjusted daylight signal resulted in significantly greater occupant acceptance over a wide range of conditions, with a significantly greater perceived accuracy of daylight control.

### 7 Alternative Embodiments

Various alternative embodiments of the subject invention are possible, and may be advantageous in certain applications, without departing from the spirit and scope of the subject invention. Examples of such alternative embodiments are discussed below.

### 7.1 Alternative Adjustment Functions

As previously noted, adjustment-determining means 23 of FIG. 4 determines an adjustment value as a function of the slat-tilt setting determined in tilt-determining means 22, the purpose of which is to adjust the output of sensor 13 to mitigate the effects of spurious daylight components. An infinite number of such adjustment functions are possible and potentially advantageous, and can be synthesized by practitioners using the information presented herein.

Potentially advantageous adjustment functions include but are not limited to those in the following categories:
a. Variations of the exemplar adjustment function shown in FIG. 5.
b. Empirically-derived adjustment functions.
c. Adaptive adjustment functions.
d. These are described in the following paragraphs.

### 7.1.1 Variations of Exemplar Adjustment Function

Referring again to FIG. 6, the exemplar adjustment function shown therein has three salient characteristics:
a. The adjustment function has a value of 1 at and below a tilt setting of −20, and its value decreases for greater tilt settings. Since the output of sensor 13 is multiplied by the adjustment function (in adjustment-application means 24 of FIG. 4), the adjustment function has no effect at or below a tilt setting of −20. The tilt setting above which the adjustment function begins to exert influence (−20 in this case) is referred to herein as the breakpoint of the adjustment function.
b. The value of the adjustment function decreases linearly between the breakpoint and the maximum tilt setting.
c. The adjustment function reaches a minimum value of 0.1 at the maximum tilt setting of 100.

Each of these characteristics can be varied to some extent without noticeably affecting the performance of system 20, while more significant variations can noticeably affect the performance in a way that can be advantageous in some situations.

### 7.1.1.1 Alternative Adjustment Function Breakpoints

Testing of the subject invention suggests two strategies for selecting the breakpoint of the adjustment function:
a. The breakpoint can be selected as the tilt setting at which the perceived luminance of the blind is expected to peak.
b. During a conventional system set-up process (not described herein), the breakpoint can be made equal to a user-selected Open tilt setting.

However, testing to date has not revealed any significant differences in the effectiveness of these approaches; prototype implementations of the subject invention work well with either approach.

### 7.1.1.1.1 Breakpoint Based on Expected Luminance Peak

Setting the breakpoint equal to the tilt setting at which the blind luminance is expected peak is potentially advantageous because the purpose of the adjustment function is to adjust the shape of the sensor output so that it more closely matches that of the luminance curve.

The −20 breakpoint of the adjustment function shown in FIG. 6 was chosen because it is typical of the tilt setting at which the perceived luminance of a horizontal blind will peak in a typical daylight-control application (e.g. in a perimeter room in an office building). For reference, a tilt setting of −20 in the arbitrary units used herein corresponds to a slat tilt angle of about −15 degrees for a typical blind design, according to the convention described in reference to FIGS. 1A-1C.

However, the actual luminance peak will depend on factors such as the design, size, and mounting height of the blind, on the height and distance from the blind from which the luminance is observed, and on the presence of buildings and trees outside the window. A breakpoint other than −20 might therefore be preferred in some applications.

For example, the perceived luminance peak will occur at a greater tilt setting when observed by a standing person than by a seated person, and as the distance from the blind increases. It should be noted that building occupants will view any given blind from multiple locations and heights, so any given adjustment function breakpoint will be a compromise.

Nevertheless, testing with a linear function of the type shown in FIG. 6 has revealed no significant differences in user assessments of system performance when the breakpoints are varied over a range −20 to 0. However, the choice of breakpoint could have a greater impact on system performance if a non-linear adjustment function is used, or if sensor 13 is not co-located with blind 10.

### 7.1.1.1.2 Breakpoint Based on User-Established “Open” Setting

As previously mentioned, the conventional set-up process used for an automatic daylight-control system using a horizontal blind typically includes the step of storing a tilt-setting that corresponds to a user-preferred open setting. This open setting is typically selected to either maximize admitted daylight under low-glare conditions or to provide the best outward view through the blind.

In certain situations, it may be advantageous to base the adjustment function breakpoint on this user-preferred open setting, rather than on an expected luminance peak. This can be done by modifying the conventional set-up process to include pre-calculation of an adjustment function which uses the open setting as the breakpoint. However, testing to date has not conclusively indicated any significant advantage of this approach over simply assuming a breakpoint close to the zero-tilt setting.

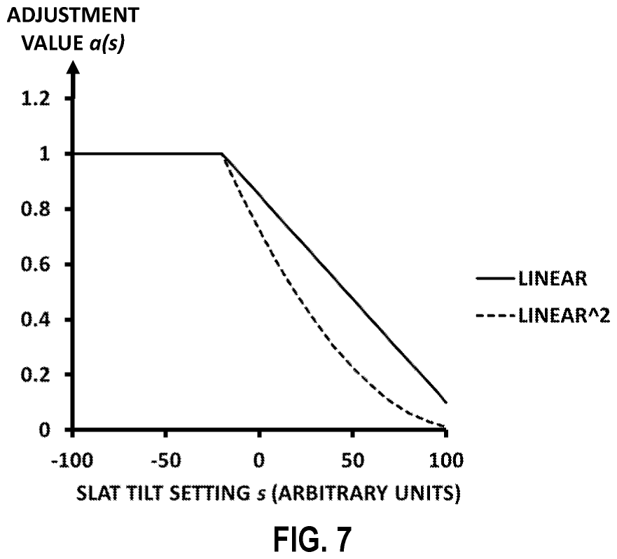

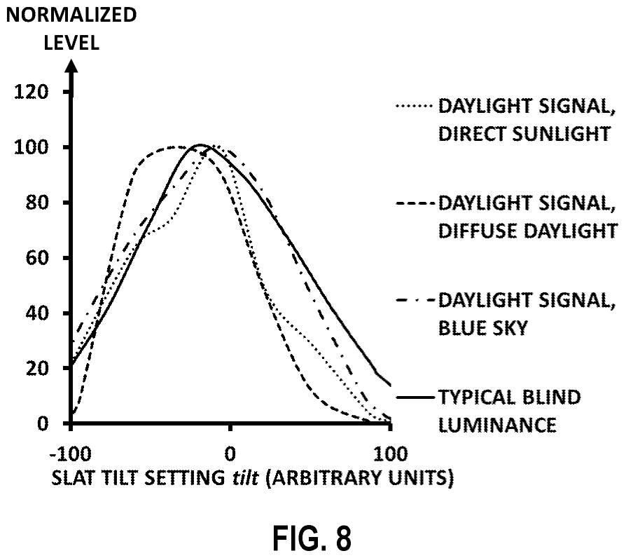

### 7.1.1.2 Alternative Shape of Adjustment Function: FIGS. 7 and 8

The exemplar adjustment function of FIG. 6 decreases linearly with tilt setting above the breakpoint. However, non-linear functions can also prove advantageous in some situations.

FIG. 7 shows such an alternative adjustment function (denoted “linear\hat{ }2”), in addition to the linear function previously shown in FIG. 6, whose value at each tilt setting is the square of the value of the linear function.

FIG. 8 shows the daylight signals obtained by applying the linear\hat{ }2 adjustment function to the same sensor output curves previously shown in FIG. 3.

When comparing FIG. 8 to FIG. 6, note that the match between the Blue Sky and luminance curve is significantly better in FIG. 8. However, the match between the Direct Sunlight and Diffuse Daylight curves is slightly poorer. Thus, the linear\hat{ }2 adjustment function of FIG. 7 is preferable when mostly clear skies without direct sun are expected, whereas the linear function is preferable otherwise.

Additional non-linear functions are of course possible and may prove advantageous, and can be evaluated in the same way as described for the linear and linear\hat{ }2 functions above.

### 7.1.1.3 Alternative Minimum and Maximum Values of Adjustment Function

The adjustment functions shown in FIG. 7 have a minimum value of 0.1 and a maximum value of 1.0. These have proven to work well in practice, but other minimum and maximum values may prove to be equally or even more effective.

### 7.1.1.4 Alternative Tilt Setting for Minimum Value of Adjustment Function

The adjustment functions of FIG. 7 reach their minimum values at a tilt setting of 100 (the closed setting). However, steeper adjustment functions which reach their minimum at a lower tilt setting can be advantageous in some situations.

### 7.1.2 Alternative Definition of Tilt Setting

As previously described, the independent variable (x-axis) of the adjustment function of FIG. 5 is the tilt setting. In the description above, the tilt setting ranges from −100 to 100, where −100 represents the negative slat-tilt limit and 100 represents the positive slat-tilt limit. However, an adjustment function could be defined for alternative definitions of the tilt setting. For example:
a. The tilt setting could be defined such that the positive tilt limit is a value other than 100, and the negative tilt limit is a value other than −100.
b. The tilt setting could represent the angular displacement of the shaft of a motor (e.g. in shaft-encoder counts) which is used to adjust a blind's slat tilt.
c. The tilt setting could represent the absolute slat-tilt angle degrees or radians, e.g. as sensed by a tilt-sensor or inferred from the motor position.

The only requirement is that the tilt-setting definition upon which the adjustment function is based must be consistent with the definition of the tilt signal produced by the tilt-determining means (e.g. tilt-determining means 22 of FIG. 4).

### 7.1.3 Empirically-Derived Adjustment Functions

According to the subject invention, an optimal adjustment function would be one which minimizes a loss function related to the differences in shapes between the daylight signal and blind luminance curves (such as those shown in FIG. 6), over a range of conditions.

While the exemplar adjustment functions of FIGS. 5 and 7 work well over a range of conditions, they are not necessarily optimal in the above sense.

A more optimal adjustment function could be synthesized by collecting and analyzing data on blind luminance and raw sensor output (without application of the adjustment function), versus slat tilt, over a particular range of conditions. Such a synthesis process could involve the following steps:
a. Defining a set of conditions over which the function should be optimized. The variables used to define each condition could include any of the following, but will typically be a subset thereof:
   i. Distance and height from the blind at which the blind luminance is sensed.
   ii. Sensor location with respect to the blind.
   iii. Blind design and size.
   iv. Room dimensions.
   v. Sky conditions (including, e.g., weather, presence of clouds, cloud type, and solar azimuth and elevation).
b. Collecting blind luminance and raw sensor output data versus slat tilt setting for each condition.
c. Calculating the ratio of the luminance to sensor output for each slat tilt setting and each condition.
d. Averaging the ratios for each slat tilt setting across all the conditions.
e. Using the resulting curve of average luminance-to-sensor-output ratio versus slat tilt setting as the adjustment function.

An adjustment function found this way is effectively the transfer function between blind luminance and sensor output, averaged across the desired set of conditions.

Practitioners will appreciate that this process need not be performed explicitly, but could instead be the result of training a machine-learned model.

While such an adjustment function could be considered optimal, the difference between such an adjustment function and the simple functions shown in FIGS. 5 and 7 has been found to be surprisingly small.

### 7.1.4 Adaptive Adjustment Function

Referring again to FIG. 3, the shapes of the sensor output curves differ significantly between the three exemplar sky conditions:
a. The Diffuse Daylight curve matches the luminance curve reasonably well.
b. The Direct Sunlight curve is shifted to the right (i.e. toward greater tilt settings). FIG. 6 shows that this shift can be corrected by multiplying the sensor output by the linear adjustment function of FIG. 5.
c. The Blue Sky curve is shifted even further to the right. FIG. 8 shows that this shift can be corrected by multiplying the sensor output by the linear\hat{ }2 adjustment function of FIG. 7.

A daylight curve which matches the luminance curve well under all three conditions can be obtained by varying the adjustment function on the basis of information characterizing the prevailing sky conditions. This can be achieved, for example, if adjustment-determining means 23 and (optionally) adjustment-application means 24 (of FIG. 4) are modified to perform the following calculation: d=s*a(tilt)\hat{ }x, where
a. d is the daylight signal produced by adjustment-application means 24,
b. s is the previously-described output of the sensor 13,
c. a(tilt) is the previously-described linear adjustment function (shown in FIG. 6) whose value is determined by adjustment-determining means 23, or is alternatively an empirically-derived adjustment function, and
d. x is an exponent that depends on the prevailing sky conditions, with the exponentiation operation performed in adjustment-determining means 23 (or, optionally, in adjustment-application means 24).

Then, if x is made equal to 0 under diffuse-daylight conditions, 1 under direct-sunlight conditions, and 2 under blue-sky conditions, the daylight signal curve is optimized for all three conditions.

The information to characterize the sky condition to determine x can be obtained in a variety of ways, including via an Application Programming Interface (API) to an online source of weather information, or via machine-learned discrimination of the output of an imaging device (camera) pointed toward the sky. However, a more cost-effective approach is to utilize a multi-spectral sensor of the type disclosed in U.S. Pat. No. 11,041,752.

### 7.1.4.1 Adaptive Adjustment Function Based on Output of Multi-Spectral Sensor

U.S. Pat. No. 11,041,752 discloses a multi-spectral daylight sensor for automated shading applications which produces a signal which depends on the ratio of the irradiances in two different spectral bands. The disclosure teaches that this signal can be used to infer the presence of glare-inducing low-angle sunlight, which in turn enables more reliable detection of daylight glare than possible using a conventional daylight sensor.

Such a sensor can also provide information on sky conditions which can be used to implement an adaptive adjustment function as described above:
a. Clear blue-sky conditions are characterized by a relatively low ratio of the irradiance at longer wavelengths to the irradiance at shorter wavelengths.
b. Direct sunlight is characterized by a relatively high ratio of the irradiance at longer wavelengths to the irradiance at shorter wavelengths.
c. Diffuse daylight is characterized by an intermediate ratio of the irradiance at longer wavelengths to the irradiance at shorter wavelengths.

Thus, the output of a multi-spectral sensor such as that disclosed in U.S. Pat. No. 11,041,752 can be advantageously used to determine the appropriate value of the exponent x in the adaptive adjustment function described above. One way of doing this is by mapping the irradiance ratio produced by the multi-spectral sensor to yield a value of exponent x of approximately 0 under uniformly bright skies (i.e. under diffuse daylight conditions), a value of approximately 2 under blue skies without direct sun, and a value of approximately 1 when there is direct sun.

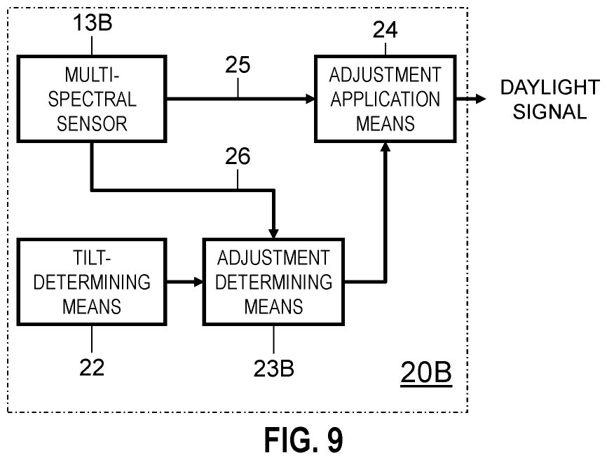

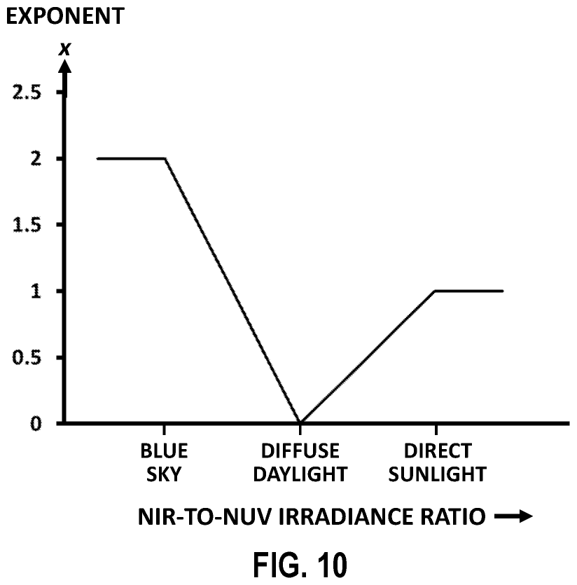

7.1.4.1.1 Alternative Embodiment Using Multi-Spectral Sensor. FIGS. 9 and 10

FIG. 9 is a block diagram of an alternative embodiment of a daylight-sensing system according to the subject invention, system 20B. Instead of a conventional irradiance sensor 13 of FIG. 4, it includes a multi-spectral daylight sensor 13B of the type shown in U.S. Pat. No. 11,041,752. As taught therein, such a sensor can include two sub-sensors whose spectral passbands are displaced in wavelength. Sensor 13B produces two output signals:
a. An irradiance signal 25 represents the irradiance in a single spectral passband and is analogous to the output of sensor 13.
b. A multi-spectral signal 26 contains information from two spectrally-displaced passbands. It can consist, e.g., of two separate signals, each representing the irradiance in one passband, or a single signal that represents the ratio of irradiances in the passbands. The following description assumes that signal 26 consists of two separate signals, one for each passband.

Typically, the sensor in a closed-loop daylight-control system will receive irradiance from an artificial lighting system as well as from daylight. To ensure that the closed-loop control is insensitive to changes in the artificial lighting, such a configuration requires that both spectral passbands of sensor 13B fall outside the spectrum of the expected artificial illumination while still overlapping the daylight spectrum. This can be achieved, for example, if a first spectral passband of sensor 13B is in the Near-InfraRed (NIR) region and a second spectral passband is in the Near-UltraViolet (NUV) region.

Irradiance signal 25 of system 20B is analogous to the output signal of sensor 13 of system 20, and directly feeds adjustment-application means 24.

Multi-spectral signal 26 (which includes an NIR irradiance signal and an NUV irradiance signal) produced by sensor 13B feeds adjustment-determining means 23B, which performs the following mathematical operation: A=a(tilt)\hat{ }x, where
a. A is the adjustment value produced by adjustment-determining means 23B for use by adjustment-application means 24,
b. a(tilt) is the value of the linear adjustment function shown in FIG. 4, and
c. x is a function of the ratio of the NIR to NUV irradiances represented by multi-spectral signal 26.

The value of x can be determined via a function such as the one shown in FIG. 10. The specific values of the NIR-to-NUV irradiance ratio associated with each sky condition will depend on the details of the implementation of sensor 13B and should be determined empirically.

Alternatively, the value of x can be obtained via a machine-learned model trained on the sky conditions and the value of multi-spectral signal 26, such that x=0 under diffuse-daylight conditions, x=1 in direct sunlight, and x=2 under blue skies. Optionally, the model can be updated over time after installation of system 20B.

### 7.1.4.2 Discrete Adaptive Adjustment Functions

In the adaptive adjustment function embodiment described above, the adjustment function is a continuous function of both the tilt setting and the exponent x. Alternatively, several discrete adjustment functions (each representing an adjustment value as a continuous function of tilt setting) could be stored in memory, such that the appropriate function could be selected on the basis of prevailing sky conditions.

Each such adjustment function could be obtained empirically, as previously described, for a particular range of sky conditions.

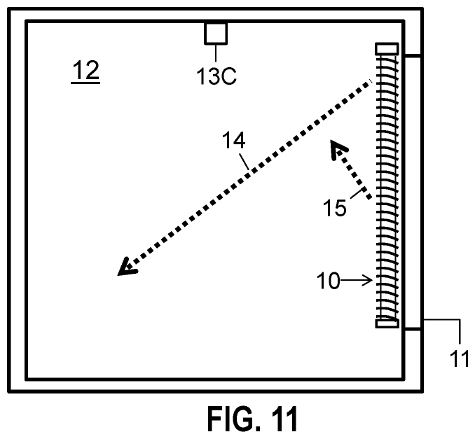

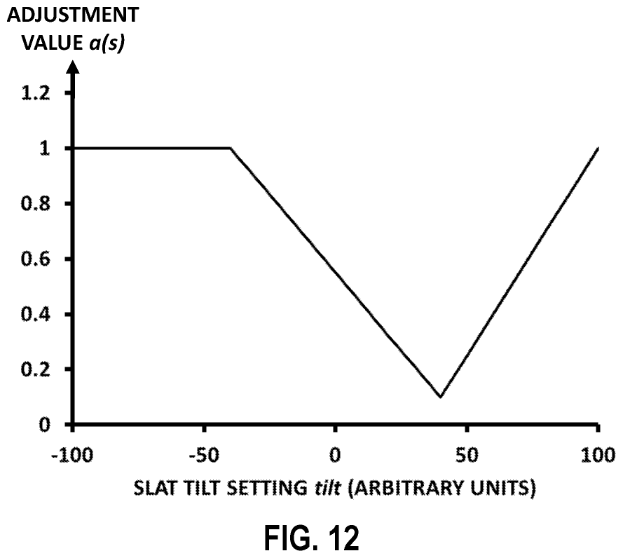

### 7.1.5 Adjustment Functions for Different Locations of Sensor 13: FIGS. 11 and 12

While co-locating sensor 13 with blind 10 as shown in FIG. 2 can minimize the cost and complexity of a daylight-control system, some applications can benefit from a different sensor location. For example, it can be advantageous to combine sensor 13 with a conventional visible-wavelength sensor, and to mount the combined sensor on the ceiling over a work-area in an office. Such a combination sensor can sense both the total illumination (e.g. to enable closed-loop control of a lighting system to maintain a constant illuminance on a work-plane) and the daylight component of the illumination (to enable closed-loop daylight control).

FIG. 11 shows such a combination sensor 13C mounted on the ceiling in room 12 (previously described). Sensor 13C requires a different output-adjustment function than does sensor 13 (of FIG. 2) to best mitigate the effects of component 15.

FIG. 12 shows an exemplar adjustment function for a ceiling-mounted sensor such as sensor 13C. Unlike the functions shown in FIGS. 5 and 7, the function of FIG. 12 has two breakpoints (instead of one), reaches its minimum value at a tilt setting lower than 100, and begins rising again toward a tilt setting of 100. This adjustment function is for purposes of illustration only; an optimal adjustment function for a ceiling-mounted sensor will depend on the specifics of the installation (e.g. the ceiling height, distance from the sensor to the blind, height of the blind, etc.), and can be synthesized using the information herein.

### 7.1.6 Adjustment Functions for Different Slat-Tilt Ranges

As previously described, closed-loop daylight control using a horizontal blind is facilitated when the slat tilt range is restricted to mostly positive angles (per the slat-tilt convention described in reference to FIGS. 1A-1C), because such angles are capable of blocking direct sunlight while still admitting diffuse daylight. For example, the slat tilt range for closed-loop control might advantageously be restricted to slat tilt settings of between −20 and 100.

However, the adjustment function as defined herein has no effect for slat tilt settings less than the breakpoint, so the adjustment function can be used over the blind's full tilt range. This may be useful, e.g., in a control algorithm which uses the mostly-positive tilt range under conditions or in installations in which direct sunlight is expected to occur, and the mostly negative tilt range under conditions or in installations in which direct sunlight is not expected to occur.

Alternatively, when a wider tilt-range is used, it may be advantageous to use an adjustment function which is not flat for tilt settings below a breakpoint (as is the case for the adjustment functions of FIGS. 5 and 7). Such an adjustment function can be obtained empirically as previously described.

### 7.1.7 Adjustment Function Obtained Via Machine Learning

As is known in the field of Artificial Intelligence (AI), functions such as those shown in FIG. 5 or 7 need not be defined analytically, but can instead be realized by training a machine-learned model.

Thus, the adjustment function implemented by adjustment-determining means 23 of FIG. 4 can be obtained via a conventional machine-learning approach that learns an optimal adjustment function using supervised training data that includes, e.g., sensor output values and blind luminance versus tilt settings.

Optionally, other information (such as the output of a multi-spectral sensor or weather information) can also be fed into the model to realize a machine-learned adaptive adjustment function.

It should be understood that the method used to derive the adjustment function, whether analytic or based on machine learning, is incidental to the subject invention.

### 7.1.8 Additional Alternative Adjustment Functions

While the adjustment function, and variations thereof, described above have proven advantageous in embodiments of the subject invention, many other such adjustment functions are possible and potentially advantageous without departing from the scope and spirit of the subject invention.

### 7.2 Alternative Ways of Applying the Adjustment Function

Referring again to FIG. 4, adjustment-application means 24 produces the daylight signal output by system 20 by multiplying the adjustment value determined by adjustment-determining means 23 by the output of sensor 13.

However, according to the subject invention, other ways of adjusting the sensor output so that it better matches the expected luminance function can be used instead, provided that the adjustment tends to cause the daylight signal to decrease with increasing tilt setting of blind 10 (over at least a portion of the blind's tilt range).

For example, an adjustment function could be defined that yields the desired daylight signal by subtracting the adjustment from the sensor output (rather than by multiplying the adjustment by the sensor output).

### 7.3 Distribution of Elements of System 20 Across Multiple Physical Assemblies

Referring again to FIG. 4, the elements of system 20 shown therein could be collocated in the same physical assembly, or distributed across multiple physical assemblies, potentially with wireless interconnections.

For example, tilt-determining means 22 could be located in a smart actuator module mounted on a horizontal blind, while the other elements of system 20 could be collocated in a ceiling-mounted module, with a wireless connection between the two modules.

### 8 Typical Application

To further facilitate an understanding of the subject invention, the following section describes a typical application for daylight-sensing system 20 (previously shown in FIG. 4).

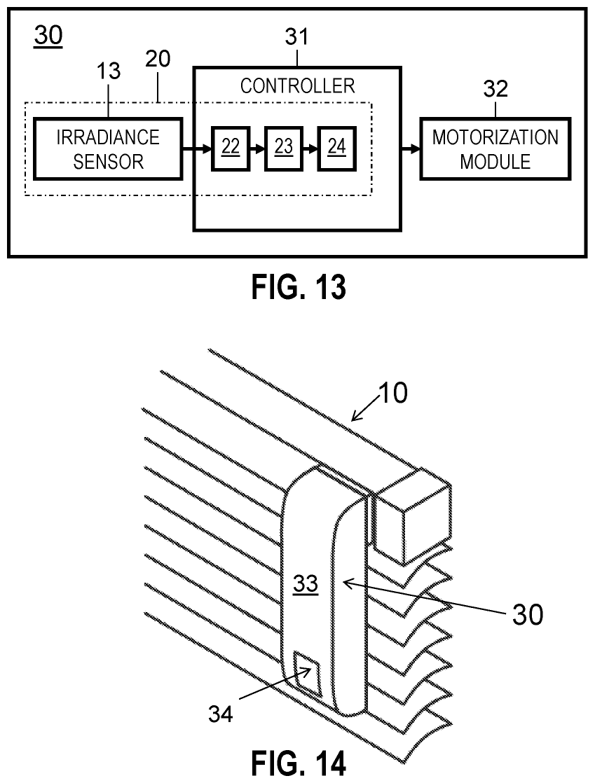

### 8.1 Block Diagram of Smart Blind Actuator Incorporating Daylight-Sensing System 20: FIG. 13

Because horizontal blinds are so widely used, devices to automate their slat-tilt function are well-known in the art. For example, such a device is shown in U.S. Pat. No. 5,760,558, and many such devices are currently commercially available.

However, insofar as is known, none of these commercially-available blind-automation devices enables its host blind to provide closed-loop daylight control. A major advantage of daylight-sensing system 20 is the ease with which it can be incorporated into such a device to provide such functionality.

To illustrate this advantage, FIG. 13 shows a block diagram of a Smart Blind Actuator 30 which incorporates daylight-sensing system 20 (previously shown in FIG. 4). Actuator 30 includes the following elements:
a. Irradiance sensor 13 of system 20 (previously described).
b. A controller 31 is a conventional device (e.g. a microcontroller) which accepts a sensor signal from sensor 13 and executes software steps to implement tilt-determining means 22, adjustment-determining means 23, and adjustment-application means 24 of system 20 (previously described). Controller 31 also performs conventional software steps associated with automatic operation of a horizontal venetian blind.
c. A motorization module 32 is a conventional device to actuate the slat-tilt function of a horizontal blind in response to commands from controller 31. It could include, for example, a motor-driven shaft coupler to rotate the tilt-adjustment shaft of a wand-actuated blind, or a motor-driven pulley to pull the cords of a cord-operated blind. A particularly advantageous implementation of motorization module 32 is the “External Motorized Actuator for Wand-Operated Venetian Blinds” disclosed in U.S. Pat. No. 11,414,927.

System 30 also includes other conventional elements (such as a user interface, wireless network interface, power supply, chassis, mounting magnets, etc.) which are incidental to the application of the subject invention and are omitted from FIG. 13 for clarity.

With the exception of sensor 13 and that portion of controller 31 which executes software steps to implement means 22, 23, and 24, smart blind actuator 30 is similar to blind automation devices which have been long known in the art and which are commercially available today. Thus, the only hardware modification to incorporate daylight-sensing system 20 in such a device is the addition of sensor 13, since controller 31 (which implements means 22, 23, and 24 via software steps) is already present.

### 8.2 Smart Blind Actuator 30 Mounted on Host Blind: FIG. 14

FIG. 14 illustrates smart blind actuator 30 mounted on blind 10. Actuator 30 includes a housing 33 to conceal the elements shown in the block diagram of FIG. 13 (and the aforementioned conventional elements not shown in FIG. 13), as well as a sensor window 34 to allow daylight irradiance to reach sensor 13 (not visible in FIG. 14).

Thus, sensor 13 (not visible in FIG. 14) is positioned in the same way, relative to blind 10, as was previously shown in FIG. 2. Therefore, the curves of FIGS. 3 and 6 are representative of the outputs of sensor 13 and daylight-sensing system 20, respectively, of FIG. 13. As previously described, these curves show that the output of system 20 (per FIG. 6) offers significantly better correlation with the perceived blind luminance than the output of sensor 13 (per FIG. 3).

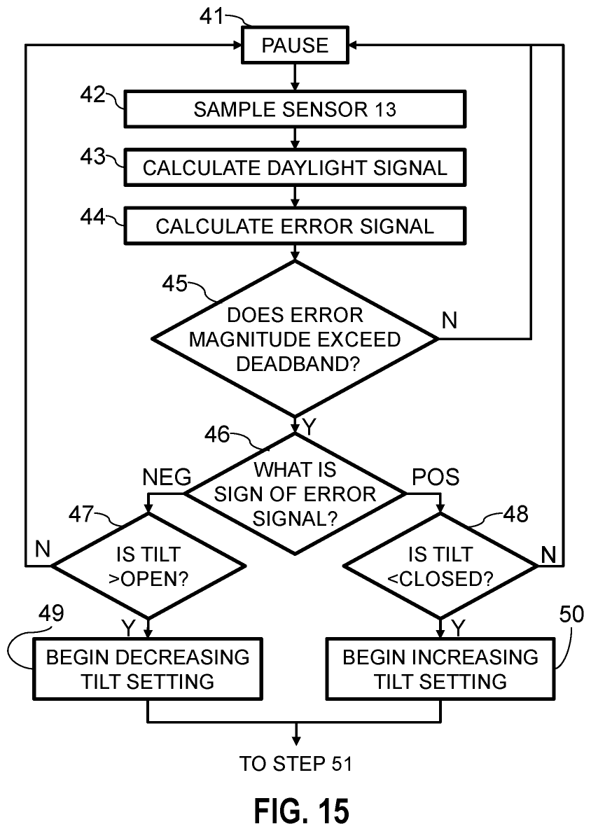

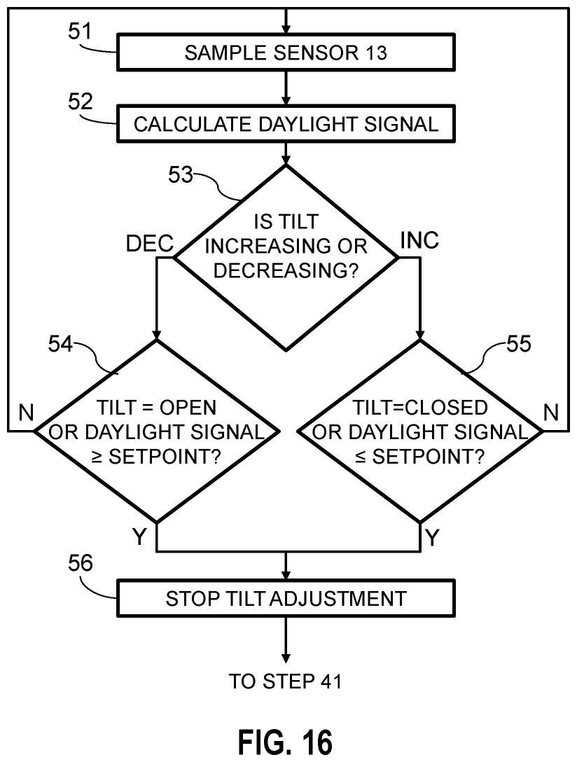

8.3 Operating Steps Associated with Closed-Loop Control Functionality of Smart Blind Actuator 30: FIGS. 15 and 16

Like conventional automated blind systems, smart blind actuator 30 is capable of responding to external commands to tilt the slats to arbitrary positions, as well as to specific preset positions (such as fully open or fully closed); it is also capable of tilting the slats to specific positions according to a time schedule, and in response to specific events such as sunrise and sunset.

However, such conventional capabilities are incidental to the application of the subject invention. Therefore, and since implementation of such capabilities is well-known in the art, the following description of the operation of actuator 30 is limited to its closed-loop daylight control functionality, as advantageously enabled by daylight-sensing system 20 according to the subject invention.

8.3.1 Operating States of Smart Blind Actuator 30 when Performing Closed-Loop Daylight Control

The closed-loop daylight control capability of actuator 30 can best be understood through separate consideration of two system operating states: the state in which the slat tilt of blind 10 is not being adjusted, and the state in which the slat tilt of blind 10 is being adjusted. Operation in other conventional system states, such as for system set-up or operation in response to external commands, are per conventional practice.

8.3.1.1 Operating Steps when Blind 10 is not being Adjusted: FIG. 15

Steps 41 through 50 of FIG. 15 represent the operating steps performed by controller 31 of actuator 30 when the tilt setting of blind 10 is not being adjusted. In general, these steps are aimed at determining if the tilt setting of blind 10 should be adjusted, and if so, if the tilt setting should be increased or decreased.

### 8.3.1.1.1 Pause Step 41 and Sampling Step 42

In a pause step 41, controller 31 (not shown in FIG. 15) waits for a sampling interval, e.g. 1 second.

Then, in a sampling step 42, controller 31 reads the output signal of sensor 13.

### 8.3.1.1.2 Calculation Step 43

Next, in a calculation step 43, controller 31 executes software steps to implement tilt-determining means 22, adjustment-determining means 23, and adjustment application means 24 of FIG. 4, to calculate a daylight signal that serves as the process variable for closed-loop control.

### 8.3.1.1.3 Calculation Step 44 and Decision Step 45

Next, in a step 44, controller 31 calculates an error signal by subtracting the daylight signal obtained in step 43 from a user-established setpoint; thus, the error signal is positive if the daylight signal exceeds the setpoint, and negative if the daylight signal is less than the setpoint. Then, in a step 45, controller 31 compares the magnitude of the error signal to a deadband; if the magnitude of the error signal is less than or equal to the deadband, then pause step 41 is repeated. This loop (consisting of steps 41 through 45) is iterated as long as the magnitude of the error signal does not exceed the deadband, enabling the system to periodically sample the daylight signal to determine if and when blind 10 should be actuated.

### 8.3.1.1.4 Decision Steps 46-48 and Action Steps 49 and 50

However, if the magnitude of the error signal exceeds the deadband, then a decision step 46 is performed which causes the program to branch depending on the sign of the error signal.

If the error signal is negative (i.e. if the daylight signal is less than the setpoint), then blind 10 should be opened (i.e. the tilt setting should be reduced), but only if the tilt setting is greater than the open setting. Therefore, in a decision step 47, controller 31 branches to an action step 49 to decrease the tilt setting of blind 10 if it is greater than the open setting; otherwise, operation branches back to pause step 41.

On the other hand, if the error signal is positive (i.e. if the daylight signal is greater than the setpoint), then blind 10 should be closed, but only if the tilt setting is less than the closed setting. Therefore, in a decision step 48, controller 31 branches to an action step 50 to increase the tilt setting of blind 10 if it is less than the closed setting; otherwise, operation branches back to pause step 41.

After either action steps 49 or 50, operation proceeds to step 51 of FIG. 16.

8.3.1.2 Operating Steps when Blind 10 is being Adjusted: FIG. 16

Steps 51 through 56 of FIG. 16 represent the operating steps performed by controller 31 of actuator 30 while the tilt setting of blind 10 is being adjusted. In general, these steps are aimed at determining if the tilt adjustment should stop.

### 8.3.1.2.1 Sampling Step 51 And Calculation Step 52

In a sampling step 51, controller 31 reads the output signal of sensor 13 in the same way as in sampling step 42 of FIG. 15.

Then, in a calculation step 52, the value of the daylight signal is calculated in the same way as in calculation step 43 of FIG. 15, i.e. by executing software instructions to implement the tilt-determining means 22, adjustment-determining means 23, and adjustment-application means 24 previously shown in FIG. 4.

### 8.3.1.2.2 Decision Steps 53-55 And Action Step 56

In a decision step 53, program flow branches depending on whether the tilt setting is increasing or decreasing.

If the tilt setting is decreasing (so that the daylight level should be increasing), then a decision step 54 is performed to check if the open setting has been reached or if the daylight signal is equal to or greater than the setpoint. If either of these conditions is met, then action step 56 is performed to stop the tilt adjustment, and program flow branches to pause step 41 of FIG. 15. Otherwise, execution returns to step 51.

If, on the other hand, the tilt setting is increasing (so that the daylight level should be decreasing), then a decision step 55 is performed to check if the closed setting has been reached or if the glare signal is equal to or less than the setpoint. If either of these conditions is met, then action step 56 is performed to stop the tilt adjustment, and program flow branches to pause step 41 of FIG. 16. Otherwise, execution returns to step 51.

### 8.4 Overall Closed-Loop Daylight-Control Operation of Smart Blind Actuator 30

Thus, per the operating steps of FIGS. 15 and 16, smart blind actuator 30 adjusts the tilt setting of blind 10 (FIG. 14) to attempt to maintain a desired level of admitted daylight based on the daylight signal produced by daylight-sensing system 20 (FIG. 13).

### 8.5 Advantages of Incorporating Daylight-Sensing System 20 in Smart Blind Actuator 30

As is known in the art, smart blind actuators such as actuator 30—but without automatic daylight-control capability—are simple and inexpensive enough for mainstream use.

However, with conventional daylight-sensing technology, using a conventional smart actuator for effective daylight control with a horizontal blind involves complications such as the need for a specialized sensor or a separate sensor assembly, and either a slat-tilt sensor or calibration of absolute slat-tilt angle against motor position.

The subject invention eliminates such complications by enabling use of a simple sensor which can be integrated into a smart actuator, while mitigating the previously-described decorrelation between sensor output and perceived blind luminance that would occur with a conventional sensor, and thereby enabling effective closed-loop daylight control.

Further, since the only hardware required to incorporate daylight-sensing system 20 in actuator 30 is sensor 13, and since the subject invention eliminates the need for specific field-of-view constraints on sensor 13 (thereby eliminating the need for baffles or lenses and minimizing the size and cost of sensor 13), actuator 30 retains virtually all of the simplicity and low cost of conventional smart blind actuators that lack automatic daylight-control capability.

Software integration of system 20 within actuator 30 is even easier: with the exception of calculation steps 43 (FIG. 15) and 52 (FIG. 16), the software steps shown in FIGS. 15 and 16 are conventional. The processing overhead required to perform calculation steps 43 and 52 is virtually negligible, even for the least-capable microcontrollers that might be used as controller 31 in a device such as actuator 30.

### 8.6 Use of Multi-Spectral Sensor

Instead of daylight-sensing system 20, any of the previously-described alternative embodiments of a daylight-sensing system according to the subject invention could be incorporated into actuator 30.

For example, substitution of daylight-sensing system 20B of FIG. 9 for daylight-sensing system 20 (as shown in FIG. 13) would add the benefits of an adaptive adjustment function (as previously described in reference to FIGS. 7, 8, and 9), with only a minor increase in cost or complexity.

### 9 Additional Applications

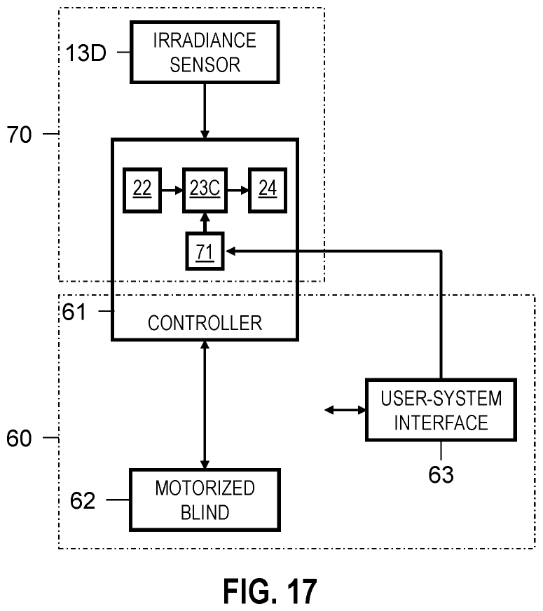

### 9.1 Augmentation of Conventional Automated Horizontal Blind: FIG. 17

The market for—and installed base of—horizontal blinds is currently dominated by manually-operated types. Therefore, a device which can automate a manually operated blind, such as smart actuator 30 of FIG. 13, is of great commercial significance.

However, the market for pre-motorized horizontal blinds is not insignificant, and a sizeable number of motorized blinds are already in use. Some motorized blinds are operated only manually via remote control (e.g. using a smartphone application), but many are automated via control logic implemented in a home-automation hub, voice-assistant, or building-management system. Due to the previously-described limitations of conventional technology, such automation virtually never includes automatic daylight control of the type addressed by the subject invention.

The subject invention enables such an automated horizontal blind to be easily augmented to provide highly effective automatic daylight control.

FIG. 17 shows a block diagram of such an augmented automated blind. It consists of a conventional automated horizontal blind 60 and a daylight-sensing system 70 according to the subject invention.

### 9.1.1 Automated Blind 60

Conventional automated blind 60 consists of a conventional controller 61 which controls a conventional motorized blind 62 and exchanges information from a conventional user-system interface 63.

Controller 61 can be a home-automation hub, a voice assistant, or the controller in a building-management system. As is typical of such devices, controller 61 includes the ability to wirelessly communicate with, and control, devices such as motorized blinds.

Motorized blind 62 is a conventional device which consists of a horizontal blind with a motorized slat-tilt function, and which is capable of receiving and acting upon slat-tilt commands issued by controller 61.

User-system interface 63 is a conventional device which enables a user to exchange information with controller 62. It can consist, e.g., of an application hosted on a smartphone.

### 9.1.2 Daylight-Sensing System 70

Daylight-sensing system 70 is similar to the previously-described system 20 of FIG. 4. It consists of a daylight irradiance sensor 13D, tilt-determining means 22 (previously described), adjustment-determining means 23C, adjustment-application means 24 (previously described), and adjustment-function-determining means 71. Means 22, 23C, 24, and 71 are implemented as software operating steps performed by controller 61.

Sensor 13D and means 22, 23C, 24, and 71 are subsequently described in greater detail.

### 9.1.2.1 Sensor 13D

Daylight irradiance sensor 13D is functionally equivalent to sensors 13 and 13C of FIGS. 2 and 11, respectively, except that it produces a wireless output signal, e.g. using the ZigBee or Thread protocols. Accordingly, it has a conventional configuration which includes a sensing element, a System-on-Chip (SoC) with wireless transceiver, and a power source (such as a battery).

### 9.1.2.2 Tilt-Determining Means 22 and Adjustment-Application Means 24

Tilt-determining means 22 and adjustment-application means 24 are as previously described in reference to FIG. 4.

### 9.1.2.3 Adjustment-Function-Determining Means 71

As previously described in reference to FIGS. 11 and 12, the appropriate adjustment function for the output of a sensor used to sense daylight admitted by a horizontal blind will depend on the location of the sensor with respect to that blind.

In the context of FIG. 17, the location of sensor 13D relative to motorized blind 62 will depend on the specifics of the installation. Sensor 13D could be collocated with blind 62 (in the same way as sensor 13 is collocated with blind 10 in FIG. 2), or it could be located separately on a ceiling (as is the case with sensor 13C of FIG. 11), or it could be located elsewhere.

The purpose of adjustment-function-determining means 71 is to determine the appropriate adjustment function according to the subject invention, depending on the location of sensor 13D with respect to blind 62, for implementation by adjustment-determining means 23C. Adjustment-function-determining means 71 is operative during a system set-up process, and is implemented via software steps which perform the following operations:
a. Receiving sensor location information from user-system interface 63. Such location information could be in the form of, e.g., a three-dimensional displacement vector with respect to blind 62. However, only coarse sensor location information is needed in order for the system depicted in FIG. 17 to be useful. Accordingly, in a preferred embodiment, the location information consists of a selection from four menu choices for the location of sensor 13D (“blind-mounted”, “ceiling-mounted”, “wall-mounted”, and “table-mounted”), which represent typical location scenarios for sensor 13D.
b. Determining an adjustment function on the basis of the sensor location information. If the location information is in the form of a three-dimensional displacement vector, the adjustment function could be determined as a mathematical function of that vector. However, in a simpler preferred embodiment, the adjustment function is determined by selecting a predetermined adjustment function corresponding to the menu selection of the sensor location. For example:
   i. If, during system set-up, the user chooses the “blind-mounted” selection via interface 63, means 71 would then select a predetermined adjustment function similar to those previously shown in FIG. 7.
   ii. If the user instead chooses “ceiling-mounted”, means 71 would then select a predetermined adjustment function similar to that previously shown in FIG. 12.
   iii. If the user instead chooses “table-mounted”, means 71 would select a predetermined adjustment function which does not alter the output of sensor 13D as a function of slat tilt. Referring again to FIG. 2, this is because a table-mounted sensor would respond to daylight component 14, which as previously described is well-correlated with the luminance of blind 10 over the blind's tilt-adjustment range. Thus, the output of a table-mounted sensor would be sufficiently well-correlated with the luminance of motorized blind 62 to not require adjustment.
   iv. If the user chooses “wall-mounted”, then means 71 would select another predetermined adjustment function synthesized according to the information provided herein (e.g. via an empirical process).
c. Providing information to adjustment-determining means 23C which defines the selected adjustment function.

### 9.1.2.4 Adjustment-Determining Means 23C

Adjustment-determining means 23C is similar to adjustment-determining means 23 of FIG. 4. However, instead of producing an adjustment value based on a single function of the slat-tilt setting provided by means 22, it produces an adjustment value as a function of one of four adjustment functions, which function is determined by the information provided by adjustment-function-determining means 71 as previously described.

9.1.3 Steps to Augment Blind 60 with Functionality of Daylight-Sensing System 70

Per the preceding discussion, automated blind 60 can be simply and easily augmented with the functionality of daylight-sensing system 70 via the following steps:
a. addition of sensor 13D,
b. modification of the software operating steps performed by controller 61, and
c. modification of the software operating steps performed by user-interface 63.

### 9.1.4 Steps to Enable Augmented System to Provide Automatic Daylight Control

After automated blind 60 has been augmented via incorporation of daylight-sensing system 70 as described above, the aggregate system can be easily modified to provide automatic daylight control by further modifying the software operating steps executed by controller 61 to include the steps described previously in reference to FIGS. 15 and 16.

### 9.1.5 Operation of Augmented System of FIG. 17

Thus, the system shown in FIG. 17 operates in the same way as smart actuator 30 of FIG. 13, except that sensor 13D, controller 61, and blind 62 are physically separate devices, and the adjustment function used by adjustment-determining means 23C depends on the location of sensor 13D (as indicated by a user during a set-up process, and communicated to means 23C by means 71).

### 9.1.6 Advantages of Augmented System of FIG. 17

The block diagram of FIG. 17 and preceding description show how the subject invention enables a conventional automated system to be easily upgraded to provide automatic daylight-control capability. Specifically, the only required hardware modification is the addition of sensor 13D; daylight-sensing and automatic daylight-control capability can then be added purely through software updates.

Further, the augmented system avoids the disadvantages of conventional automatic daylight-control technology while also providing flexibility in the mounting location of sensor 13D.

### 9.2 Alternative Embodiments of Augmented Automated Blind

Instead of daylight-sensing system 70, any of the previously-described alternative embodiments of a daylight-sensing system according to the subject invention could be used to augment automated blind 60 in the manner described for system 70.

### 9.2.1 Multi-Spectral Sensor and Adaptive Adjustment Function

For example, augmenting automated blind 60 with a daylight-sensing system similar to that of system 20B of FIG. 9, instead of daylight-sensing system 70 (as shown in FIG. 17) is feasible, and would add the benefits of multi-spectral sensing and an adaptive adjustment function (as previously described in reference to FIGS. 7, 8, and 9), with only a minor increase in cost or complexity.

9.2.2 Augmentation of Automated Blind with Dedicated Controller

In automated blind system 60 of FIG. 17, controller 61 is independent of, and physically separate from, motorized blind 62. However, virtually all motorized blinds incorporate a dedicated controller to manage motor operation, and some such dedicated controllers are capable of providing programmable automated shading functionality (such as dusk/dawn or scheduled open/close operation) without need for a home-automation hub or voice assistant.

However, whether the controller is independent of the motorized blind, or is dedicated to it, is incidental to applying the subject invention to augment an automated blind as shown in FIG. 17. Provided that the controller's software can be updated, an automated blind with a dedicated controller can be augmented with the subject invention in the same way as automated blind 60 of FIG. 17.

### CONCLUSION

As this disclosure makes clear, the subject invention enables a simple, easy-to-implement means of producing a daylight signal which can be used for effective closed-loop daylight control with horizontal blinds. It overcomes significant disadvantages of conventional daylight-sensing approaches for automatic daylight control with horizontal blinds:
a. By enabling effective closed-loop control, it avoids the disadvantages of open-loop control, including the need to characterize the blind's transfer function, the need for a separate sensor assembly, the need for either a slat-tilt sensor or a slat-tilt calibration procedure, and the need to sense or infer the angular distribution of the incident irradiance.
b. At the same time, it avoids the disadvantages of closed-loop control with conventional sensing approaches, including the need for a daylight sensor which is collocated with building occupants, or a sensor which has specialized characteristics (such as an optimized field-of-view or vector-sensing capability) which complicate sensor integration but which are necessary to ensure adequate correlation between the sensor output and the perceived blind luminance.

The subject invention thus eliminates a significant barrier to mainstream use of automatic daylight-control technology.

Those skilled in the art will recognize that the construction, function, and operation of the elements composing the preferred and alternative embodiments described herein may be modified, eliminated, or augmented to realize many other useful embodiments, without departing from the scope and spirit of the invention as disclosed herein and recited in any appended claims.

I claim:

1. A daylight-sensing system to produce a daylight signal in response to daylight admitted by a horizontal venetian blind, said blind having an adjustable slat tilt setting, said system including:
a. a sensor to sense a component of said admitted daylight, said sensor producing a sensor signal;
b. tilt-determining means to determine said tilt setting;
c. adjustment-determining means to determine an adjustment value as a function of said tilt setting; and
d. adjustment-application means to produce said daylight signal by applying said adjustment value to said sensor signal.

2. The daylight-sensing system of claim 1 wherein said slat tilt setting is adjustable between an open setting and a closed setting, and wherein said adjustment value reduces said daylight signal as said tilt setting is adjusted toward said closed setting.

3. The daylight-sensing system of claim 1 wherein said function depends on a location of said sensor relative to said blind.

4. The daylight-sensing system of claim 1 wherein:
a. said system includes characterizing means to obtain information characterizing a sky condition; and
b. said adjustment value depends on said information.

5. The daylight-sensing system of claim 4 wherein said characterizing means includes a multi-spectral sensor.

6. The daylight-sensing system of claim 4 wherein said characterizing means includes an interface to a source of weather information.
